(19) United States
(12) Patent Application Publication
(10) Pub. No.: US 2025/0384205 A1
(43) Pub. Date: Dec. 18, 2025

(54) SYSTEM AND METHOD FOR IMPOSING PDF FILES FOR PRINT DEVICES USING EXISTING PAGE LAYOUT DESIGN TOOLS

(71) Applicant: Meadows Information Systems, LLC d/b/a Meadows Publishing Solutions, Schaumburg, IL (US)

(72) Inventor: John A. Kriho, La Grange Park, IL (US)

(73) Assignee: Meadows Information Systems, LLC d/b/a Meadows Publishing Solutions, Schaumburg, IL (US)

(21) Appl. No.: 19/236,044

(22) Filed: Jun. 12, 2025

Related U.S. Application Data
(60) Provisional application No. 63/659,491, filed on Jun. 13, 2024.

(51) Int. Cl. G06F 40/186; G06F 16/93; G06F 40/106

(52) U.S. Cl. CPC G06F 40/186; G06F 16/93; G06F 40/106

(57) ABSTRACT

A method to generate a document for printing is provided. A plurality of imposition parameters is received within a template file, where the plurality of imposition parameters includes a file path for an input data file, the input data file comprising a plurality of data elements. A plurality of frames within the template file are generated based on the parameters, and each of the plurality of frames is assigned an identifier to receive a data element from the input data file. An imposition document including the plurality of frames, the plurality of imposition parameters is generated, and an identifier is assigned to each of the plurality of frames. An imposed document is generated based on the imposition document and the input data file, where generating the document comprises imposing each data element from the input data file into a corresponding frame of the plurality of frames within the imposition document.

### CLAIM OF PRIORITY

This application claims the benefit of U.S. Provisional Application Ser. No. 63/659,491, filed on Jun. 13, 2024, which is hereby incorporated by reference in its entirety.

### FIELD

The present invention relates to creating template documents for publishing or printing, and more particularly to a system and method for creating document templates that are designed for performing imposition for printing.

### BACKGROUND

Imposition is a step in the printing and publishing process that involves arranging individual pages or items onto a larger print sheet in a manner that maximizes space utilization, supports correct page order, and facilitates efficient post-processing. Imposition can involve placing multiple unique pages (N-up), repeating the same page multiple times (Step and Repeat), or organizing pages for folding and binding (booklet imposition).

However, conventional software tools to perform imposition provide only basic or rigid imposition capabilities. As a result, users have limited flexibility to define how individual pages, whether unique or repeated, are arranged on a larger print sheet. This makes it difficult to efficiently organize multiple items per sheet, particularly for small-format documents. Additionally, conventional tools often lack features for precise positioning, spacing, rotation, or alignment of imposed pages, which can lead to misaligned outputs and irregular spacing. These limitations reduce overall workflow efficiency and make high-volume, variable-data printing tasks more labor-intensive and error-prone.

### SUMMARY

A first aspect of the present disclosure provides a method to generate a document for printing, the method comprising: receiving, via a user interface of a page layout application, a plurality of imposition parameters for generating a plurality of frames within a template file, wherein the plurality of imposition parameters includes a file path for an input data file, the input data file comprising a plurality of data elements; generating, by the page layout application, based on the plurality of imposition parameters, the plurality of frames within the template file, wherein based on a plurality of data elements present in the input data file, each of the plurality of frames is assigned an identifier to receive a data element from the input data file; creating, by the page layout application and based on the template file, an imposition document that includes the plurality of frames, the plurality of imposition parameters, and the identifier assigned to each of the plurality of frames; and generating an imposed document, by the page layout application, based on the imposition document and the input data file, wherein generating the document comprises imposing each data element from the input data file into a corresponding frame of the plurality of frames within the imposition document, based on the plurality of imposition parameters and the identifier assigned to each of the plurality of frames.

According to an implementation of the first aspect, assigning each of the plurality of frames with the identifier comprises: determining whether the plurality of data elements in the input data file are sequential; and based on determining that the plurality of data elements in the input data file are sequential, assigning unique identifiers to each of the plurality of frames, wherein each of the unique identifiers corresponds to a data element of the plurality of data elements.

According to an implementation of the first aspect, the unique identifiers are assigned to each of the plurality of frames in an ascending order.

According to an implementation of the first aspect, the unique identifiers assigned to each of the plurality of frames are sequential.

According to an implementation of the first aspect, generating the imposed document comprises imposing each data element of the plurality of data elements on a frame with a corresponding unique identifier in the template file.

According to an implementation of the first aspect, based on determining that the plurality of data elements in the input data file is not sequential, assigning a same identifier to each of the plurality of frames, wherein the identifier assigned to the plurality of frames corresponds to a non-sequential content element of the plurality of data elements.

According to an implementation of the first aspect, the plurality of imposition parameters comprises a number of frames to be generated within the template file.

According to an implementation of the first aspect, the plurality of imposition parameters comprises a size of each frame to be generated within the template file, wherein the size of each frame is determined based on a size of data elements present within the input data file.

According to an implementation of the first aspect, the size of each frame is manually modified after the frame is placed within the template file.

According to an implementation of the first aspect, generating the imposed document comprises: converting the template file to a template document, wherein converting the template document comprises storing the plurality of imposition parameters within a document structure of the template document; and imposing each data element from the input data file into a corresponding frame of the plurality of frames within the template document.

According to an implementation of the first aspect, generating the imposed document comprises: converting the template file to a template document, wherein converting the template file comprises storing the plurality of imposition parameters within a metadata file external to the template document; and imposing each data element from the input data file into a corresponding frame of the plurality of frames within the template document.

According to an implementation of the first aspect, generating the imposed document comprises: determining, based on the plurality of imposition parameters, whether printer markers are to be generated in the document; and generating the printer markers in the document based on the determination.

According to an implementation of the first aspect, imposing each data element from the input data file into a corresponding frame of the plurality of frames within the template file comprises: determining, based on the plurality of imposition parameters, a size of each of the plurality frames within the template file; and resizing a data element based on the size of the corresponding frame before imposing the data element into the corresponding frame.

According to an implementation of the first aspect, resizing the data element based on a size of the corresponding frame comprises cropping the data element based on a size of the corresponding frame before imposing the data element into the corresponding frame.

According to an implementation of the first aspect, the plurality of frames are generated by a plug-in application of the page layout application.

According to an implementation of the first aspect, generating the imposed document comprises: retrieving, by the page layout application, the imposition document, based on a second file path for the imposition document provided to an imposition interface of the page layout application interface; retrieving, by the page layout application, the input data file based on the file path; and generating the imposed document, by the page layout application, based on the imposition document and the input data file.

According to an implementation of the first aspect, the plurality of imposition parameters and the identifier assigned to each of the plurality of frames of the template file are stored as part of a document structure associated with the imposition document.

According to an implementation of the first aspect, the plurality of imposition parameters and the identifier assigned to each of the plurality of frames of the template file are stored as part of a separate file associated with the imposition document, where the separate file is stored along with the imposition document.

A second aspect of the present disclosure a system to generate a document for printing, the system comprising: a page layout application configured to: receive, via a user interface, a plurality of imposition parameters for generating a plurality of frames within a template file, wherein the plurality of imposition parameters includes a file path for an input data file, the input data file comprising a plurality of data elements; generate, by the page layout application, based on the plurality of imposition parameters, the plurality of frames within the template file, wherein based on a plurality of data elements present in the input data file, each of the plurality of frames is assigned an identifier to receive a data element from the input data file; create, by the page layout application and based on the template file, an imposition document that includes the plurality of frames, the plurality of imposition parameters, and the identifier assigned to each of the plurality of frames; and generate an imposed document, by the page layout application, based on the imposition document and the input data file, wherein generating the document comprises imposing each data element from the input data file into a corresponding frame of the plurality of frames within the imposition document, based on the plurality of imposition parameters and the identifier assigned to each of the plurality of frames.

A third aspect of the present disclosure includes a tangible, non-transitory computer-readable medium for generating a document for printing, having instructions thereon, which, upon being executed by one or more processors, provides for execution of the following steps: receiving, via a user interface, a plurality of imposition parameters for generating a plurality of frames within a template file, wherein the plurality of imposition parameters includes a file path for an input data file, the input data file comprising a plurality of data elements; generating, by the page layout application, based on the plurality of imposition parameters, the plurality of frames within the template file, wherein based on a plurality of data elements present in the input data file, each of the plurality of frames is assigned an identifier to receive a data element from the input data file; creating, by the page layout application and based on the template file, an imposition document that includes the plurality of frames, the plurality of imposition parameters, and the identifier assigned to each of the plurality of frames; and generating an imposed document, by the page layout application, based on the imposition document and the input data file, wherein generating the document comprises imposing each data element from the input data file into a corresponding frame of the plurality of frames within the imposition document, based on the plurality of imposition parameters and the identifier assigned to each of the plurality of frames.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 illustrates a system for imposing files for print devices, according to one or more embodiments of the present disclosure;

FIG. 2A depicts an exemplary interface of the template generator for generating an imposition template, according to one or more embodiments of the present disclosure;

FIG. 2B illustrates an exemplary layout of the imposition frames in the imposition template, according to one or more embodiments of the present disclosure;

FIG. 2C illustrates an exemplary layout of the imposition frames in the imposition template, according to one or more embodiments of the present disclosure;

FIG. 2D illustrates an exemplary interface of the template generator, according to one or more embodiments of the present disclosure;

FIG. 2E illustrates an exemplary conversion of the imposition template from a native format to a generic format, according one or more embodiments of the present disclosure;

FIG. 3A depicts an exemplary interface of the imposer for generating an imposition template, according to one or more embodiments of the present disclosure;

FIG. 3B illustrates an exemplary process of performing imposition using the input document and the imposition file to generate a publication document, according to one or more embodiments of the present disclosure;

FIG. 3C illustrates modifying data items as they are inserted from the input document into an imposition frame, according to one or more embodiments of the present disclosure;

FIG. 3D depicts overlaying printer makers in the publication document based on imposition settings, according to one or more embodiments of the present disclosure;

FIG. 4 is a simplified block diagram of one or more devices or systems within the exemplary environment of FIG. 1, according to one or more examples of the present disclosure; and

FIG. 5 illustrates an exemplary process to perform imposition for printing, according to one or more examples of the present disclosure.

### DETAILED DESCRIPTION

Examples of the present application will now be described more fully hereinafter with reference to the accompanying FIGS., in which some, but not all, examples of the application are shown. Indeed, the application may be exemplified in different forms and should not be construed as limited to the examples set forth herein; rather, these examples are provided so that the application will satisfy applicable legal requirements. Where possible, any terms expressed in the singular form herein are meant to also include the plural form and vice versa, unless explicitly stated otherwise. Also, as used herein, the term “a” and/or “an” shall mean “one or more” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on”.

Conventional imposition tools generate printing layouts using a rigid, grid-based arrangement for placing items on a printing sheet. The grid-based layout provided by conventional tools often cannot be used to accommodate intricate layout of items for printing. Beyond limitations in placement and sizing, traditional imposition tools also offer limited flexibility in defining and designing custom templates. This makes it difficult to use conventional printing systems for complicated printing jobs.

For example, the conventional imposition tools often cannot be used to generate different imposition layouts including a scatter layout, staggered layout, or a Dutch-cut Layout. Because conventional imposition tools are restricted in their ability to be customized based on the type of data items to be printed, conventional imposition tools often increase wastage of resources and creates in inefficiencies in the printing process.

Embodiments of the present disclosure provide a method for individually positioning each item within a printer sheet to maximize page space. For example, each of the items that are placed on the printer sheet may be placed at unique locations, rotation angles, and have customizable formatting preferences.

Embodiments of the present disclosure provide an imposition workflow for variable data printing (VDP) by reusing native features of page layout software to visually and interactively design imposition templates. Unlike traditional rigid grid-based imposition tools, this method allows designers to use familiar tools such as Adobe InDesign picture frames to designate imposition zones. Each imposition zone is enhanced with metadata describing layout attributes and sequencing and marked with a visible non-printable banner for user clarity. These templates are exported to generic formats (e.g., PDFs) enriched with imposition metadata.

The entire imposition workflow, as described in embodiments of the present disclosure, including the execution of the final imposition process, may be initiated from within the page layout environment-such as Adobe InDesign-without requiring the user to leave the application. This allows seamless integration and user experience continuity, while internally coordinating with a separate imposition engine that handles PDF merging and output generation.

Embodiments of the present disclosure provide a separate merging process the templates and user-supplied data PDFs use to produce a final imposed output, aligning each data record to its corresponding frame based on metadata. The result is a flexible, designer-driven approach to VDP imposition that integrates seamlessly into existing layout workflows. The disclosed imposition workflow allows for reusing of native features of the page layout software application to perform variable data printing (VDP).

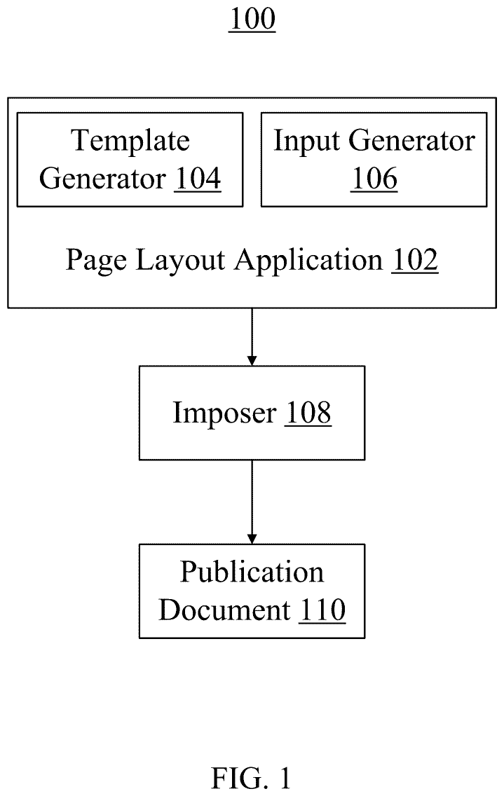

FIG. 1 illustrates a system for imposing files for print devices, according to one or more embodiments of the present disclosure. System 100 shown in FIG. 1 includes a page layout application 102. The page layout application 102 includes a template generator 104, an input file generator 106, and an imposer 108. In some embodiments, the page layout application 102 may be an application such as Adobe InDesign, published by Adobe Systems Inc. In such embodiments, the template generator 104, the input file generator 106, and the imposer 108 may be plug-in applications within the page layout application 102 (e.g., Adobe InDesign, published by Adobe Systems Inc.).

The page layout application 102 may be used to generate a publication document 110 for printing, based on an input document generated using the input file generator 106. In some embodiments, the input generator 104 of the page layout application 104 may be used to generate the input document for printing by combining pictures, text, typography, writing, and editing. Examples of input documents that may be generated using the page layout application 102 may be brochures, business cards, postcards, letters, pamphlets, and catalogs. In some embodiments, the input documents that are created include content that is frequently changed or updated. For example, in the context of a postcard to be mailed to more than one recipient, each postcard may be modified to replace the personalized information (e.g., name, address, phone number, photo, etc.) for each recipient.

The input generator 106 may be configured to assist in the personalization of publications by reading the content to be replaced in the input document from a database table or a text-based data file and replacing the corresponding data in the publication using that data. When the data has been replaced, a new document, or a graphical representation of the input document (e.g., a portable data format (PDF) file) may be produced. In some instances, it is desirable to produce a single, multi-page file where each page or set of pages contains personalized content. For example, in the case of the input document being a postcard, as described above, the multi-page document may include a plurality of postcards on different pages, where each postcard is personalized using a different recipient's information, including name, address, and phone number.

In some alternate embodiments, the input document may include static content, i.e., content that is not personalized for different users. In such embodiments, the input document may include one page, or multiple pages of static content. The input document generated by the page input generator 106 is provided to the imposer 108 for generating the publication document 110 for printing.

The template generator 104 is configured to design and generate an imposition template to arrange multiple items onto a print sheet during the imposition process, to generate the publication document 110. In some embodiments, the template generator 104 specifies how individual pages of the input document, are to be arranged, oriented, positioned, and spaced, within a page of the template. For example, the template generator 104 provides an imposition frame for each item of the input document that is to be placed on the print sheet. Each page of the input document is placed within an imposition frame placed in the imposition template. The imposition frame identifies a position, dimensions, rotation, and cropping of the pages of the input document. The dimensions of the frame indicate the overall height and width of the imposed item from the input document, and the location defines the positioning of the imposed item in an x-y coordinate system within the overall template page design, typically but not limited to using the top/left corner of the frame as the positioning point of reference.

For the purposes of this disclosure, an imposition frame is a content frame that is specially designated-either by metadata tagging, appearance modification, or both—to serve as a placeholder and positional guide for imposed content based on the input document, such as variable-data pages from a multi-page input document (e.g., a PDF file). Unlike conventional frames, an imposition frame includes additional attributes, such as a sequence number, trim rules, scaling or rotation settings, and may include a non-printable visual indicator for designer clarity. These frames are repurposed to not display static content within the page layout application, but to define where dynamic or personalized content will be merged in a subsequent imposition step.

As an item of the input document is imposed within the imposition frame of imposition template, the input item is modified based on the settings assigned to the imposition frame. In addition to the dimensions and location of the imposed item on the page, the imposition frame may also be assigned a trim to be applied to the item when it is imposed onto the sheet. In some embodiments, the items to be imposed onto the imposition template may be larger in dimension than the defined dimensions of the imposition frame. In such embodiments, items from the input document are trimmed before imposing in the publication document to match the dimensions/bounding box area defined by the imposition frame, or to match other commonly accepted predefined trim areas, such as a trim box, or a bleed box.

Furthermore, the imposition frame generated by the template generator 104 may be assigned other attributes, such as an offset within the defined frame area to position the item, a scaling factor to be applied to the item, and a final alignment of the item within the defined frame area, such as center, left, right, top, bottom.

In some embodiments, imposition frames may be a variation of a general content frame that is part of the page layout application 102. In such cases, the imposition frames may be distinguished from general content frames of the page layout application 102 by storing the aforementioned assigned attributes with the imposition frame. The attributes of the imposition frame may be added by the template generator 104 to the imposition frame using application programming interfaces (APIs) that communicate with the page layout application 102.

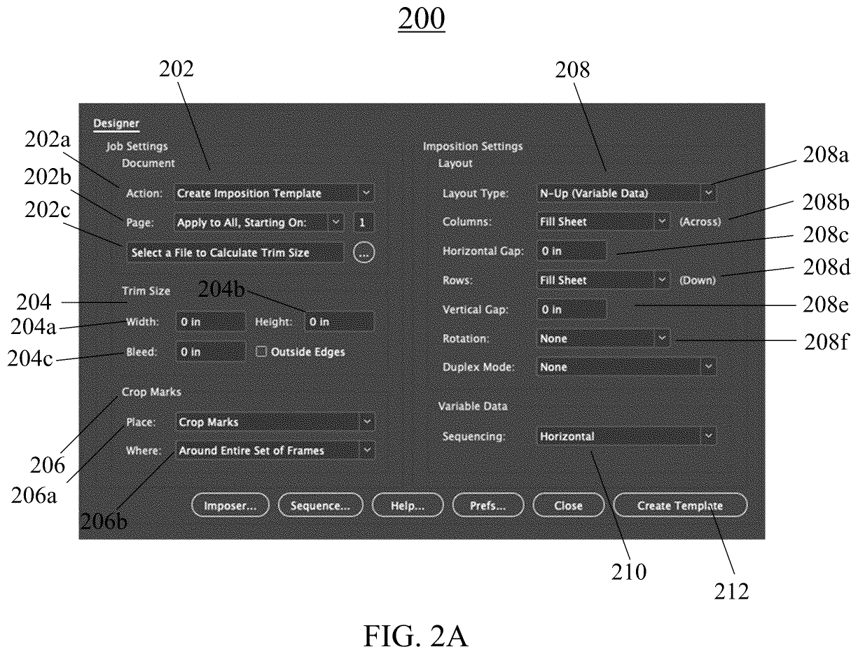

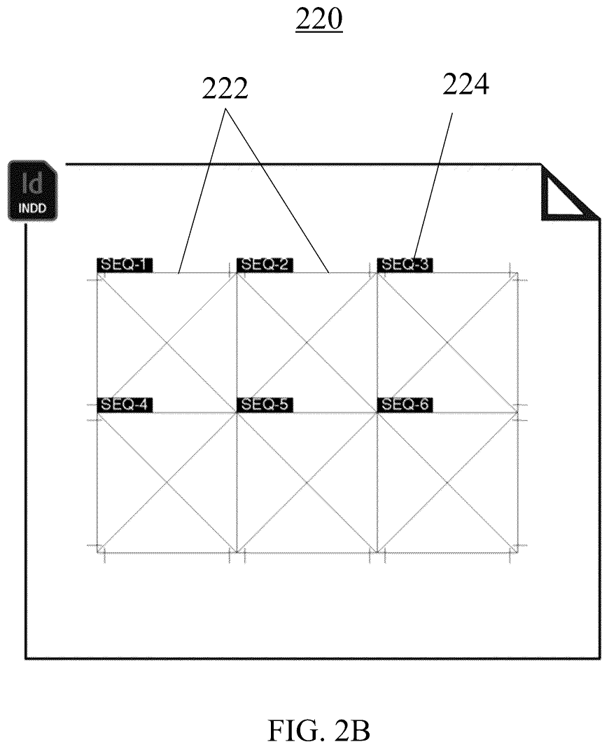

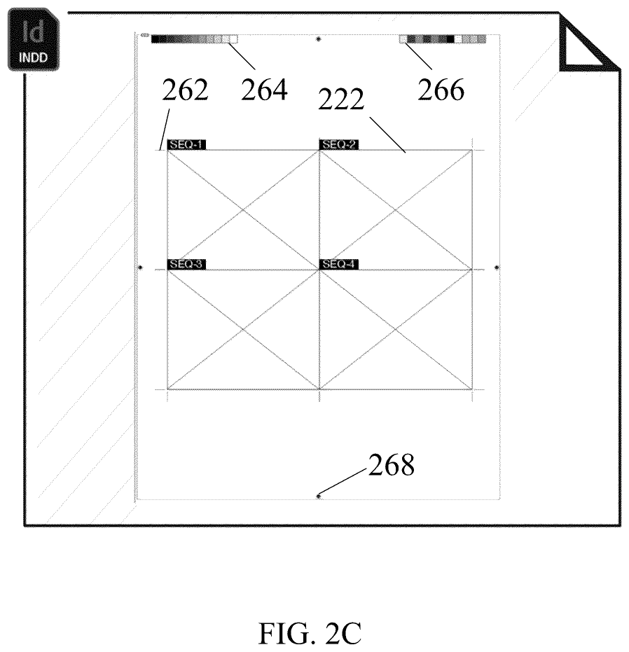

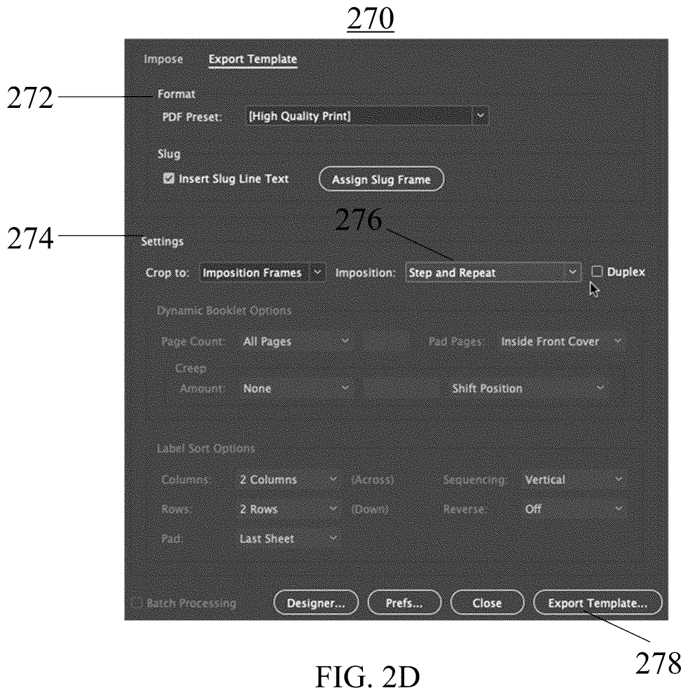

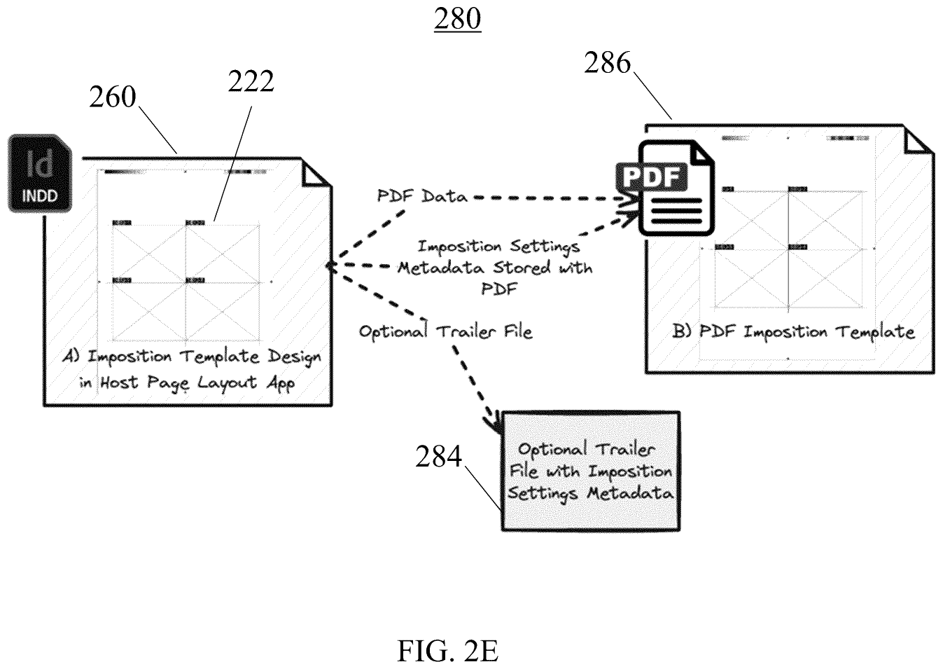

In some examples, the special attributes of the imposition frame may include differentiating features such as border, color, or any other unique attribute that can be applied to the imposition frame using the page layout application 102. The creation and positioning of the imposition frames within the imposition template may be assisted by a user interface that assists in the initial creation of the imposition frames in the imposition template. An user exemplary interface for creating the imposition frames in the imposition template is shown in detail with respect to FIG. 2A.

The attributes assigned to the imposition frames in the imposition templates include a sequence value that will be assigned to each imposition frame. The sequence value may be a sequential integer value that indicates the order in which the imposition frames present in the imposition template may be processed during the imposition of the input document on the imposition template.

Processing the imposition frames in the processing order based on the sequence value allows for the different items of the input document to be imposed in the imposition frames of the imposition template in an order so as to avoid overlap of adjacent items. For example, in the specific case of personalized (or variable data) printing, the sequencing may be used to ensure each imposed item is placed in the process order for proper “sorting” of the printed objects (for example, a pre-sorted series of direct mail postcards, or a series of sequentially numbered labels, all of which must be printed in a defined order). In some additional embodiments, the indication of the process order ensures the items of the input document are placed onto the imposition template are in the process order that is appropriate for a printer or post-processing device (e.g., cutter, slitter, die cutter) that will process the imposed sheets once they have been printed. Once the imposition frames have been created and positioned in the imposition template, the imposition template design process is complete. Subsequently, the imposition template is saved by the page layout application 102 as an imposition document. As part of the saving process, the page layout application 102 converts the imposition template from a native document format supported by the page layout application 102 into a generic document format (e.g., PDF) which may serve as a base template or canvas to be used for the imposition process.

Converting the imposition template from the native document format to the imposition document of a generic document format may include storing, along with the imposition template, information for completing the imposition process. For example, information for completing the imposition process includes location and dimensions of the imposition frames taken from the imposition template, along with all assigned attributes as discussed previously. Additionally, there may be supplementary attributes that may be stored with the converted imposition template that may be necessary for special processing instructions. Collectively this information that is stored with the converted imposition template may be referred to as the imposition settings or the “imposition settings metadata or metadata”.

All metadata information may be exported and stored directly within the imposition document file structure using any available method for storing such persistent data as provided for in the file specification. As an optional approach, rather than embedding the imposition metadata within the imposition document, a separate trailer file that contains the imposition-specific metadata may be created. The trailer file may be created in conjunction with the imposition document and initially saved in the same location as the imposition document. Once the imposition document is created, the imposition document, including the imposition specific metadata, is stored and may be used at any time to generate the publication document 110.

In some embodiments, in order to generate the publication document 110, the generated imposition document is provided by the template generator 104 to the imposer 108. In alternate embodiments, the page layout application 102 may retrieve imposition document and the imposition metadata for the imposition process.

The imposer 108 utilizes the input document and the imposition document to generate the publication document 110. The imposer 108 may use the positioning information included in the imposition settings stored as metadata in the imposition document, or as included in the optional trailer file, to determine the manner in which the pages of the input document are imposed onto the imposed document to form the publication document 110. The imposer 108 subsequently places the content of each page of the input document into the imposition frame location of the imposition document to form the publication document 110. The content of the input document as it is inserted into the imposition frame of the imposition document may be modified based on the settings assigned to the imposition frames. In some embodiments, the imposed items will be placed into the publication document in the sequence order specified for each frame in the imposition template. For example, an imposition frame labeled as 1, may receive the first page of the input document, and so on.

In some embodiments, the template generator 104 and the imposer 108 may be plug-in applications that are provided within the page layout application 102.

FIG. 2A depicts an exemplary interface of the template generator 104 for generating an imposition template, according to one or more embodiments of the present disclosure. A user may interact with the template interface window 200 of the template generator 104 to generate an imposition template. Template interface window 200 of FIG. 2A includes five different portions. Interface window 202 depicts a document section 202. The document section 202 includes input fields for specifying an action setting 202a, a page setting 202b, and an input file path 202c. As shown in FIG. 2A, the action setting 202a may be a drop-down menu with a variety of options. From the various options, in order to generate an imposition template, the option of “Create Imposition Template” may be selected. Similarly, the page setting 202b may be a drop-down menu with a variety of options. Each option may specify how the settings listed in the template interface window 200 may be applied to the imposition template. By default, the settings specified in the template interface window 200 may be applied to all pages starting from the first page. In case the user wishes to specify the imposition template settings specified in the template interface window 200 only be applied to certain pages, the user may specify that in the page settings 202b. A file path for the input document, that is to be used to generate the publication document 110, is specified in the input field for the file path 202c.

The trim size section 204 of the template interface window 200 provides input fields for specifying a width 204a, height 204b, and bleed 204c of each imposition frame to be placed within the imposition template. In some embodiments, the width 204a and height 204b of the imposition frames to be placed in the imposition template may be based on the width and height of the items present in the input document specified once the file path is provided in the input field 202c. The template generator 104 may analyze the input document specified by the file path mentioned at 202c to determine a width and height for the items present in the input document. The width and height of the items present in the document may be used to determine the width and height of the imposition frames. The determined width and height of the imposition frames may be populated by the template generator 104 into the width 204a and height 204b fields in the trim size section 204 of the template interface window 200. Additionally, in case a user wishes to have the imposition frames bleed into one another, the user may specify the dimensions of the bleed in the bleed field 204c of the trim size section 204. In some alternate embodiments, a user may manually enter the width and height of the imposition frames to be generated by the template generator 104.

In some embodiments, the size of the imposition frame may be determined without analyzing the input document. In such embodiments, a user may manually specify the width 204a and the height 204b of each imposition frame within the imposition template in the trim size section 204 of the template interface window 200.

The template interface window 200 includes a crop marks section 206. In the crop marks section 206, the user may specify whether cropping handles are to be displayed associated with the imposition frames. For example, crop marks section 200 includes a placement field 206a and a location field 206b. Placement field 206 may be a drop-down menu that may be used to specify whether crop marks are to be placed in relation to the imposition frames in the imposition templates. Location field 206b may be another drop-down menu that may be used to specify a location where the crop marks, selected in placement field 206a, are to be placed.

Template interface window 200 includes a layout section 208. The layout setting section 208 may be used to specify details for providing a layout of the imposition frames within the imposition template. The layout section 208 includes a layout type input field 208a. The layout type input field 208 may be a drop-down menu with a variety of options. For example, the options in the drop-down menu of the layout type input field 208 may include “N-Up (Variable Data),” “Step and Repeat,” and “2up Saddle Stitch.” In some embodiments, the layout type of “N-Up (Variable Data)” may be selected when the input document includes various instances of a document (e.g., a postcard) that is personalized with specific information associated with a variety of users (e.g., name, address, photo). In such embodiments, each of the imposition frames that are generated may be assigned a unique sequence number that corresponds to sequential items within the input document. In alternate embodiments, the layout type of “Step and Repeat” may be selected when the input document includes a single item that is to be repeated multiple times in the publication document 110. In such embodiment, each of the imposition frames that are generated are assigned a same sequence number that correspond to the single item within the input document. In alternate embodiments, the layout type of “2up Saddle Stitch” may be selected when the input document includes items to be printed as a booklet in the publication document 110.

The layout section 208 includes a number of columns field 208b and a number of rows field 208d. The template generator 104 generates a number of imposition frames for the imposition template based on a specified number of rows and columns in the input fields 208b and 208d respectively. For example, if the number of columns specified in the number of columns field 208b is four (4) and the number of rows (3) specified in the number of rows field 208d is three (3), the template generator 104 may generate a total of twelve (12) imposition frames, arranged in three (3) rows and four (4) columns in a center of the imposition template. In some cases, instead of specifying a number of rows and a number of columns, the template generator 104 may be instructed to fill the imposition template in the horizontal and vertical direction. In such embodiments, the number of imposition frames within the imposition template may be determined based on the size of the imposition frame as specified in the trim size 204 section of the template interface window 200.

In a default configuration, the imposition frames generated by the template generator 104 may abut each other in the horizontal and vertical direction. The layout section 208 includes a horizontal gap input field 208c and a vertical gap input field 208e. The spacings specified in the horizontal gap input field 208c and the vertical gap input field 208e may be used to create space between the imposition frames generated by the template generator 104, in the horizontal and vertical and directions respectively.

Layout section 208 includes a rotation input field 208f. The rotation input field 208f may be used to specify an orientation of the imposition frame that is generated by the template generator 104.

The template interface window 200 includes a sequencing input field 210. The sequencing input field 210 may be a drop-down menu with a variety of options. In some embodiments, one of the options of the drop-down menu of the sequencing input field 210 may be horizontal. In such a case, the imposition frames generated by the template generator 104 within the imposition template may be assigned incremental unique sequential identifiers in a horizontal direction. Alternatively, one of the options of the drop-down menu of the sequencing input field 210 may be vertical. In such a case, the imposition frames generated by the template generator 104 within the imposition template may be assigned incremental unique sequential identifiers in a vertical direction.

Once the various settings within the template interface window 200 are specified, the imposition template may be created by pressing the button 212 labelled “Create Template.” Once the button 212 labelled “Create Template” is selected, an imposition template including a plurality of imposition frames is created.

FIG. 2B illustrates an exemplary layout of the imposition frames in the imposition template generated by the template generator 104, according to one or more embodiments of the present disclosure. FIG. 2B includes an imposition template 220 that includes a plurality of imposition frames 222. As discussed with respect to FIG. 2A, the number of imposition frames 222 generated within the imposition template 220 may be based on the settings specified in the template interface window 200 (shown in FIG. 2A). For example, the number of imposition frames generated within the imposition template 220 may be based on the number of rows and columns specified in the number of rows field 208d and the number of columns field 208b within the template interface window 200 as depicted in FIG. 2A. Additionally, the dimensions of each of the imposition frames 222 may be determined based on the size of the items present in the input document. The size of the items present in the input document may be determined by the template generator 104 and populated within the fields 204a and 204b of the trim size section 204 of the template interface window 200.

For the same of example, FIG. 2A depicts a total of six (6) imposition frames distributed over three (columns) and two (2) rows. Each imposition frame shown in the imposition template 220 may be assigned an identifier 224. Identifier 224 associated with the imposition frames 222 may be depicted in the form of a non-printable banner. In some embodiments, the identifier 224 assigned to the imposition frames 222 may be determined based on the layout type selected in the layout type field 208a in the template interface window 200 of FIG. 2A. In case the layout type selected in the layout type field is N-Up (Variable Data), the identifiers 224 assigned to the imposition frames 222 are sequential and unique. Each sequential unique identifier that is assigned to an imposition frame 222 may correspond to an item within the input document.

In some embodiments, the layout of the imposition frames 222 may be a default layout provided by the template generator 104. Additionally, there may be no space provided between the imposition frames 222 by default. In some embodiments, that setting may be modified in the template interface the spacing between the imposition frames 222 may be specified in the template interface window 200 (shown in FIG. 2A). Additionally, and/or alternatively, a location of each of the content frames 222 shown in the imposition template 220 may be manually moved around the imposition template 220 as needed using the available features provided by the page layout application 102.

FIG. 2C illustrates an exemplary layout of the imposition frames in the imposition template, according to one or more embodiments of the present disclosure. The imposition frames 222 as shown in FIGS. 2B and 2C may be provided by the page layout application 102 as a variation of generic content frames provided by the page layout application 102. Additionally, a user may wish to add graphical elements to the imposition template such as crop marks and trim marks 262, color bars 264 and 266, registration marks 268, and other common printing elements. The items from the input document may be added to the imposition template using the features provided by the page layout application 102.

FIG. 2D illustrates an exemplary export interface window, according to one or more embodiments of the present disclosure. Once the imposition frames 222 (shown in FIG. 2B) are added to the imposition template 220, and attributes are assigned to the imposition template are added (as shown in FIG. 2C), the process to design the imposition template is complete. The export interface window 270 may be used to save the designed imposition template. In some embodiments, saving the imposition template converts or exports the imposition template from a native document format supported by the page layout application 102 into an imposition document having a generic document format. The imposition document in the generic document format may serve as the base template or canvas to be used during the imposition process.

The export interface window 270 as shown in FIG. 2D allows a user to specify settings when converting or exporting the imposition template into the imposition document. Export interface window 270 includes a format section 272 and a settings section 274. In the format section 272, the generic document format in which the imposition template is to be converted from the native document format is specified. For example, the generic document format may be a portable document format (PDF).

In the settings section 274, a type of imposition to be performed using the imposition template and the input document is specified in the imposition input field 276. In some embodiments, the field 276 may be automatically populated by the template generator 104 based on the inputs provided in the template interface window 200 and the nature of the input document specified in the file path 202c (shown in FIG. 2A). Once the settings are specified, the imposition template may be converted or exported as an imposition document by selecting the button “Export Template” 278 at the bottom of the export interface 270.

FIG. 2E illustrates an exemplary conversion of the imposition template from a native format to a generic format, according one or more embodiments of the present disclosure. Once the settings to convert or export the imposition template 260 from the native format of the page layout application 102 (shown in FIG. 1) to generate an imposition file in a generic format are specified in the export interface 270 as shown in FIG. 2D, the template generator 104 creates an imposition document 286 in a generic document format.

In some embodiments, when the imposition template 260 is converted or exported to generate the imposition file 286, information related to complete the imposition process is stored along with the imposition file. This information may include the location and dimensions of the imposition frames 222 taken from the imposition template 260, along with all other assigned attributes. The assigned attributes may include processing preferences associated with the frames in the imposition template. For example, the processing preferences may include indication of whether the imposition frames 222 have a sequential identifier assigned to them, or a same identifier assigned to them. In case the imposition frames 222 have a sequential identifier assigned to them, then the imposition frames 222 may be processed sequentially with an input document that has a plurality of items. In case the imposition frames 222 have a same identifier assigned to them, then the imposition frames 222 may be processed an input document that has a single item. Additionally, as discussed previously, the assigned attributes may include dimensions of the imposition frames, spacing between the imposition frames, and other features assigned to the imposition frames via the template interface window 200 shown in FIG. 2A. Collectively this information may be referred to as the imposition settings or the imposition settings metadata or simply the metadata. All such metadata information shall be exported and stored directly within the file structure of the imposition file 286 using any available method for storing such persistent data as provided for in the structure of the imposition file 286. In some embodiments, the metadata may be stored within the file structure of the imposition file 286. The metadata may be stored JSON objects, using XML tags, or with any other appropriate format in the structure of the imposition file 286.

Additionally, and/or alternatively, rather than embedding the imposition metadata within the imposition file 286, a separate trailer file 284 may be generated to store the imposition metadata. The trailer file 284 may be created in conjunction with the imposition file 286 and may be saved in the same location as the imposition file 286. The trailer file 284 may be a JSON file, an XML file, or have any other suitable format.

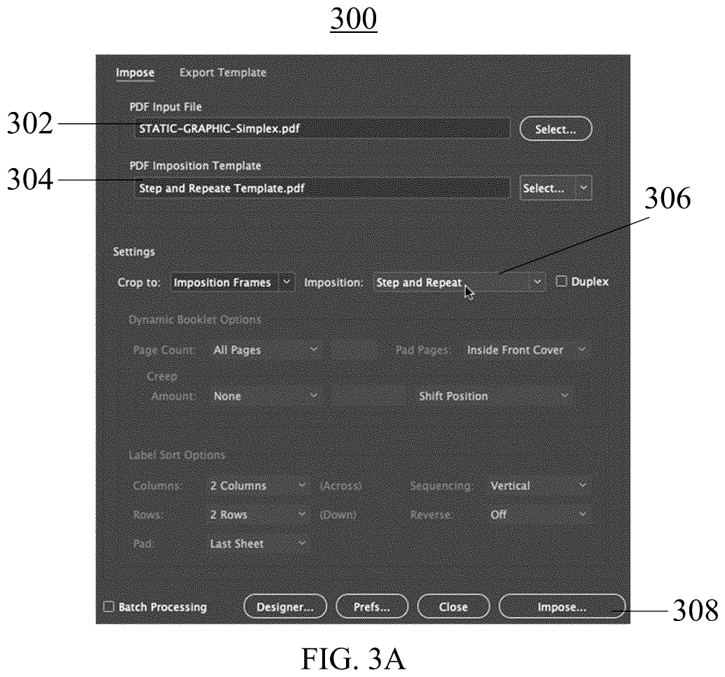

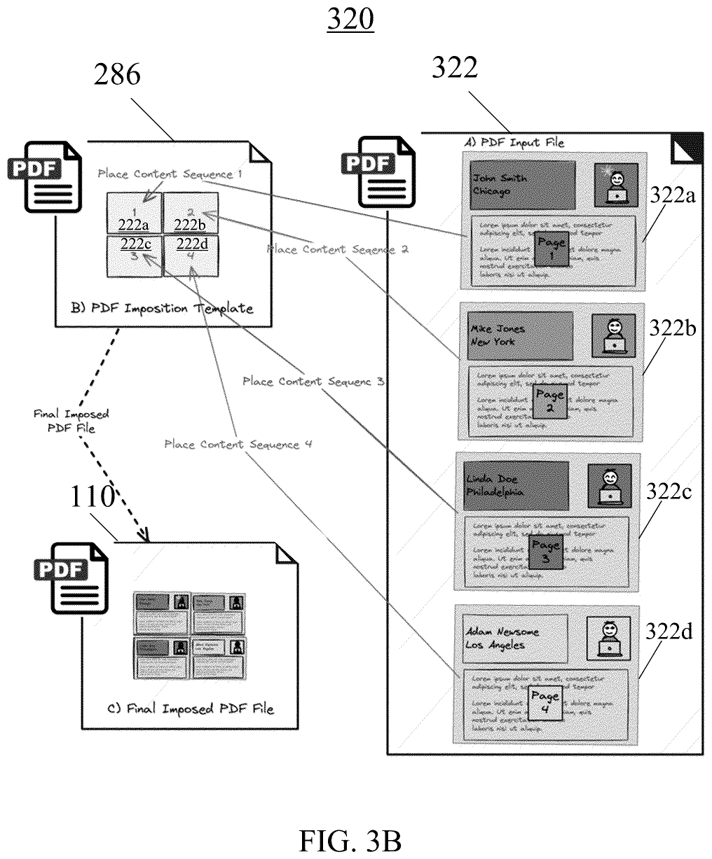

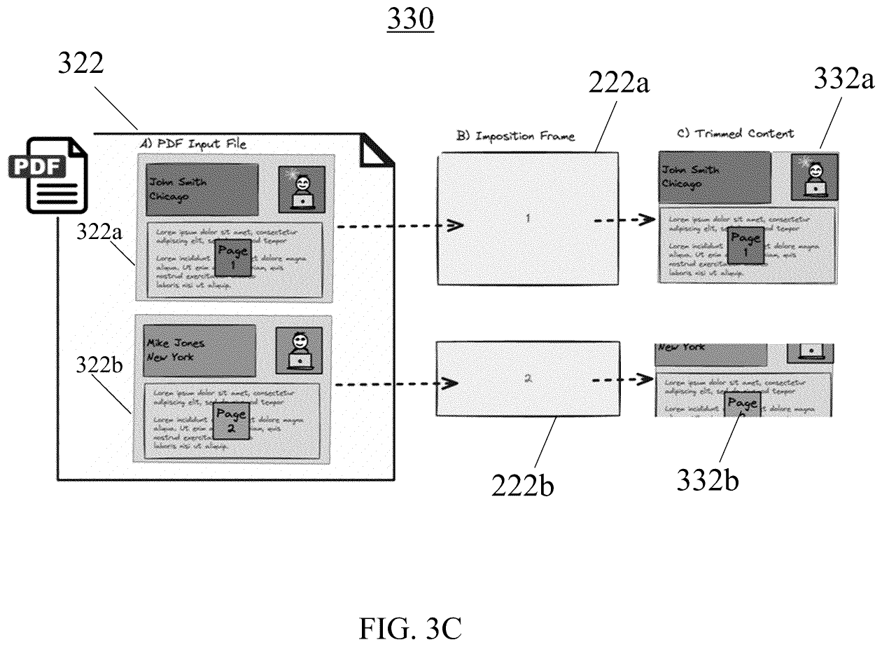

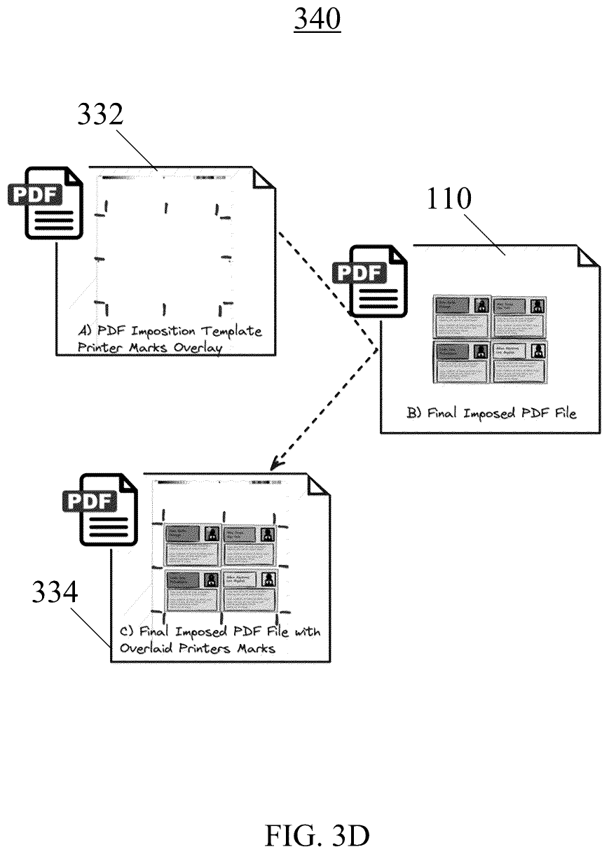

FIG. 3A depicts an exemplary interface of the imposer 108 for generating an publication document, according to one or more embodiments of the present disclosure.

Imposition interface window 300, as shown in FIG. 3A depicts first input field 302 and a second input field 304. A file path for the input document is provided in the first input field 302, and a file path for the imposition file is provided in the second input field 304.

The imposition interface window 300 includes an imposition input field 306 that receives as input, a kind of imposition to be performed using the input document and the imposition file to generate a publication document 110 (as discussed with respect to FIG. 1). Other parts of the imposition interface window 300 may be used to configure other settings related to the imposition to be performed. Once the settings are finalized, the imposition process is started by selecting the button 308 that is labelled “Impose.”

FIG. 3B illustrates an exemplary process of performing imposition using the input document and the imposition file to generate a publication document, according to one or more embodiments of the present disclosure. The process 320 illustrated in FIG. 3B includes an imposition document 286, an input document 322, and a publication document 110, that is generated using the imposition document 286 and the input document 322.

As discussed with respect to FIG. 2E, the imposition document 284 includes imposition frames 222a-222d. The imposition frames may be assigned identifiers for processing during the imposition process. In some embodiments, the imposition frames may be assigned identifiers when the imposition template is generated, as discussed with respect to FIGS. 2A-2E. In case the input document, provided at the time of creating the imposition template, includes a variety of sequential data items, the imposition frames 222a-222d of the imposition document 286 may be provided with unique sequential identifiers. Additionally, and/or alternatively, in case the input document, provided at the time of creating the imposition template, includes a single data item, the imposition frames 222a-222d of the imposition document 286 may be provided with the same identifier.

In FIG. 3B, the input document 322 includes a plurality of sequential data elements. For example, the input document 322 includes a first data item 322a, a second data item 322b, a third data item 322c, and a fourth data item 322d. Each of the data items 322a-322d may be a document that is customized with name, address, and picture for a different recipient.

As discussed previously, the imposition document 286 may have metadata information stored within the structure of the imposition document 286 that specifies the imposition settings associated with the imposition frames 222a-222d of the imposition document 286. The imposition settings may include sequence numbers assigned to each imposition frame of the imposition document 286. In some embodiments, the metadata information may be stored in a separate file (also known as trailer file). The page layout application 102 may process the imposition document 286 and the input document 322 using the metadata information.

For example, imposition document 286 includes a plurality of imposition frames 222a, 222b, 222c, and 222d. As discussed previously, each of the plurality of frames 222a-d may be assigned a unique sequential identifier. For example, imposition frame 222a is assigned a unique sequential identifier SEQ1, imposition frame 222b is assigned a unique sequential identifier SEQ2, imposition frame 222c is assigned a unique sequential identifier SEQ3, and imposition frame 222d is assigned a unique sequential identifier SEQ4. When the imposition process is initiated, based on selecting the “Impose” button 308 in the imposition interface window 300, a new publication document 110 is generated using the imposition document 286 and the input document 322. For example, the publication document 110 is generated by providing the first data element 322a from the input document 322 to the imposition frame 222a. Similarly, the second imposition frame 222b may be configured to receive the second data item 322b in the input document 322. The third imposition frame 222c may be configured to receive the third data item 322c in the input document 322 and the fourth imposition frame 222d may be configured to receive the fourth data item 322d in the input document 322.

In some embodiments, in case the input documents have more data items, when the current page of the publication document 110 has been filled with imposed items 322a-322d, a new page will be inserted into the publication document 110 as needed to accommodate the remaining data items from the input document 322 to be imposed. In some embodiments, if there are not enough imposed items to fill out all of the defined imposition frame positions for a given page, by default the remaining frame positions will be left as empty positions in the publication document 110. There may be additional options provided to the user via a preference setting allowing them to handle empty positions in a different fashion, such as to fill the empty frames with a pre-specified image or file, or to position the empty frames on the first or last page of the publication document 110.

In some embodiments, as the data item from the input document 322 is inserted into a corresponding imposition frame 222, the data item from the input document may be modified based on settings assigned to the imposition frames. In some embodiments, the settings may be specified in the template interface window 200 as discussed with respect to FIG. 2A, or may be assigned after the imposition frames are inserted within the imposition template. The attributes provided to the imposition frames may be related to rotating, scaling, cropping, positioning, and otherwise modifying the data item as it is inserted within the imposition frame 222.

FIG. 3C illustrates modifying data items as they are inserted from the input document into an imposition frame, according to one or more embodiments of the present disclosure.

FIG. 3C depicts a portion of the input document 322. An imposition frame 222a of the imposition document is configured to receive the first data item 322a of the input document 322. An imposition frame 222b of the imposition document is configured to receive the first data item 322b of the input document 322. As shown in FIG. 3C the imposition frame 222a has a different size compared to the size of the data item 322a. Based on the settings assigned to the imposition frame 222a, the data item 322a of the input document 322 may be cropped and centered within the imposition frame 222a to generate the content 332a for the publication document 110. Additionally, and/or alternatively, the imposition frame 222b has a different size compared to the size of the data item 322b. Based on the settings assigned to the imposition frame 222b, the data item 322b of the input document 322 may be cropped and centered within the imposition frame 222b to generate the content 332b for the publication document 110.

In alternate embodiments, the settings assigned to the imposition frames 222a and 222b may be different compared to the settings of the corresponding data items 322a and 322b. For example, the orientation of the imposition frames 222a and 222b may be different compared to the settings of the corresponding data items 322a and 322b. In such embodiments, the orientation of the data items 322a and 322b may be modified, based on the settings of the imposition frames 222a and 222b, before it is inserted in the imposition frames 222a and 222b in the publication document 110.

In some embodiments, the number of imposition frames 222 in the imposition document 286 may be fewer in number than the number of data items in the input document 322. For example, an imposition document may include four (4) imposition frames 222, and the input document 322 may include 24 data items. In such an example, the imposer 108 may impose four (4) data items of the input document 322 in corresponding frames of the imposition document 322 to create the publication document 110. In such examples, the imposition process performed by the imposer 108 automatically replicates the imposition frames from the imposition document 286, as needed, to accommodate all the data items from the input document 322.

FIG. 3D depicts overlaying printer markers in the publication document based on imposition settings, according to one or more embodiments of the present disclosure. As discussed previously, settings specified when the imposition template is generated using the template interface window 200 may include whether crop marks are to be displayed in the imposition template. As discussed previously, the template interface window 200 (shown in FIG. 2A) includes a crop marks section 206. In the crop marks section 206, the user may specify whether cropping handles are to be displayed associated with the imposition frames. For example, crop marks section 206 includes a placement field 206a and a location field 206b. Based on the settings specified in the crop marks section 206 of the template interface window 200, the page layout application 102 may overlay the publication document 110 with printer markers 332, including crop marks, color bars, or any other printing elements that were defined by the user when the initial imposition template was generated using template interface window 200.

In some embodiments, the printer markers 332 are overlayed on top of the newly imposed pages of the publication document 110 to ensure that items such as crop marks are not obscured by the imposed items of the publication document 110 themselves. The overlay may occur at the end of the process, having previously assembled all pages in the publication document 110, or it may occur as each page is added to the publication document 110. Once the overlay of the printer markers 332 is performed, the final publication document 334 is generated.

In some embodiments, the settings assigned to the imposition frames of the imposition document 286 may also include a preference setting that provides control over the ordering of the items to be overlayed onto the imposition document 110. This preference may allow a user to specify the “Z-ordering” of the items as they are placed onto a page of the publication document 110. In some embodiments, this may be achieved by using “Layers”, which may be part of the page layout application 102. The use of layers allows the user to specify the order in which data items from the input document are to be placed onto a page of the publication document 110 by placing those data items onto specific layers and then specifying the order in which a layer of objects is placed onto the page. This provides for control of item overlap in the final publication document 334.

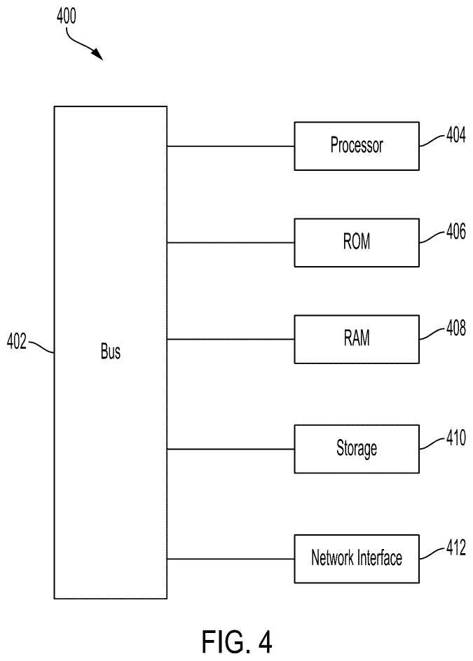

FIG. 4 is a block diagram of an exemplary system or device 400 within the environment 100. The system 400 includes a processor 404, such as a central processing unit (CPU), and/or logic, which executes computer executable instructions for performing the functions, processes, and/or methods described herein. In some examples, the computer executable instructions are locally stored and accessed from a non-transitory computer readable medium, such as storage 410, which may be a hard drive or flash drive. Read Only Memory (ROM) 406 includes computer executable instructions for initializing the processor 404, while the random-access memory (RAM) 408 is the main memory for loading and processing instructions executed by the processor 404. The network interface 412 may connect to a wired network or cellular network and to a local area network or wide area network. The system 400 may also include a bus 402 that connects the processor 404, ROM 406, RAM 408, storage 410, and/or the network interface 412. The components within the system 400 may use the bus 402 to communicate with each other. Additionally, and/or alternatively, the system 400 may further include components that might not be included within every entity of environment 400. For instance, in some examples, the system 100 might not include a network interface 412.

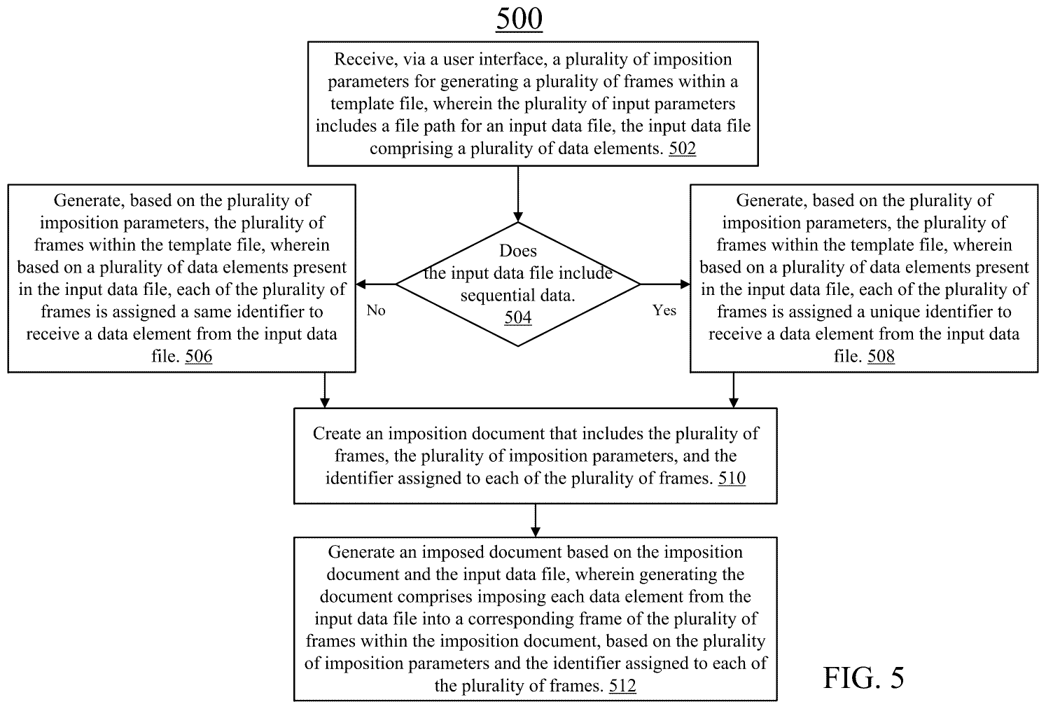

FIG. 5 illustrates an exemplary process to perform imposition for printing, according to one or more examples of the present disclosure. In some embodiments, the process 500 may be performed by the system 100 of FIG. 1, e.g., by the page layout application 102. However, it will be recognized that any of the following blocks may be performed in any suitable order and that the process 100 may be performed in any environment and by any suitable computing device and/or controller.

At 502, the page layout application, receives, via a user interface, a plurality of imposition parameters for generating a plurality of frames within a template file, wherein the plurality of input parameters includes a file path for an input data file, the input data file comprising a plurality of data elements.

At 504, the page layout application, determines whether the input data file include sequential data. Based on determining that the input data file includes sequential data, the process 500 proceeds to to 508 to generate, based on the plurality of imposition parameters, the plurality of frames within the template file, wherein based on a plurality of data elements present in the input data file, each of the plurality of frames is assigned a unique identifier to receive a data element from the input data file.

Based on determining that the input data file does not include sequential data, the process 500 proceeds to 506 to generate, based on the plurality of imposition parameters, the plurality of frames within the template file, wherein based on a plurality of data elements present in the input data file, each of the plurality of frames is assigned a same identifier to receive a data element from the input data file.

At 510, the page layout application, creates an imposition document that includes the plurality of frames, the plurality of imposition parameters, and the identifier assigned to each of the plurality of frames.

At 512, the page layout application, generates an imposed document for printing based on the imposition document and the input data file, wherein generating the document comprises imposing each data element from the input data file into a corresponding frame of the plurality of frames within the template file, based on the plurality of imposition parameters and the identifier assigned to each of the plurality of frames.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above. The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method to generate a document for printing, the method comprising:
receiving, via a user interface of a page layout application executing on a computing device, a plurality of imposition parameters for generating a plurality of frames within a template file, wherein the plurality of imposition parameters includes a file path for an input data file, the input data file comprising a plurality of data elements;
generating, by the page layout application, based on the plurality of imposition parameters, the plurality of frames within the template file, wherein based on a plurality of data elements present in the input data file, each of the plurality of frames is assigned an identifier to receive a data element from the input data file;
creating, by the page layout application and based on the template file, an imposition document that includes the plurality of frames, the plurality of imposition parameters, and the identifier assigned to each of the plurality of frames; and
generating an imposed document, by the page layout application, based on the imposition document and the input data file, wherein generating the document comprises imposing each data element from the input data file into a corresponding frame of the plurality of frames within the imposition document, based on the plurality of imposition parameters and the identifier assigned to each of the plurality of frames.

2. The method of claim 1, wherein assigning each of the plurality of frames with the identifier comprises:
determining whether the plurality of data elements in the input data file are sequential; and
based on determining that the plurality of data elements in the input data file are sequential, assigning unique identifiers to each of the plurality of frames, wherein each of the unique identifiers corresponds to a data element of the plurality of data elements.

3. The method of claim 2, wherein the unique identifiers are assigned to each of the plurality of frames in an ascending order.

4. The method of claim 3, wherein the unique identifiers assigned to each of the plurality of frames are sequential.

5. The method of claim 2, wherein generating the imposed document comprises imposing each data element of the plurality of data elements on a frame with a corresponding unique identifier in the template file.

6. The method of claim 2, based on determining that the plurality of data elements in the input data file is not sequential, assigning a same identifier to each of the plurality of frames, wherein the identifier assigned to the plurality of frames corresponds to a non-sequential content element of the plurality of data elements.

7. The method of claim 1, wherein the plurality of imposition parameters comprises a number of frames to be generated within the template file.

8. The method of claim 1, wherein the plurality of imposition parameters comprises a size of each frame to be generated within the template file, wherein the size of each frame is determined based on a size of data elements present within the input data file.

9. The method of claim 8, wherein the size of each frame is manually modified after the frame is placed within the template file.

10. The method of claim 1, wherein generating the imposed document comprises:
converting the template file to a template document, wherein converting the template document comprises storing the plurality of imposition parameters within a document structure of the template document; and
imposing each data element from the input data file into a corresponding frame of the plurality of frames within the template document.

11. The method of claim 1, wherein generating the imposed document comprises:
converting the template file to a template document, wherein converting the template file comprises storing the plurality of imposition parameters within a metadata file external to the template document; and
imposing each data element from the input data file into a corresponding frame of the plurality of frames within the template document.

12. The method of claim 1, wherein generating the imposed document comprises:
determining, based on the plurality of imposition parameters, whether printer markers are to be generated in the document; and
generating the printer markers in the document based on the determination.

13. The method of claim 1, wherein imposing each data element from the input data file into a corresponding frame of the plurality of frames within the template file comprises:
determining, based on the plurality of imposition parameters, a size of each of the plurality frames within the template file; and
resizing a data element based on the size of the corresponding frame before imposing the data element into the corresponding frame.

14. The method of claim 10, wherein resizing the data element based on a size of the corresponding frame comprises cropping the data element based on a size of the corresponding frame before imposing the data element into the corresponding frame.

15. The method of claim 1, wherein the plurality of frames are generated by a plug-in application of the page layout application.

16. The method of claim 1, wherein generating the imposed document comprises:
retrieving, by the page layout application, the imposition document, based on a second file path for the imposition document provided to an imposition interface of the page layout application interface;
retrieving, by the page layout application, the input data file based on the file path; and
generating the imposed document, by the page layout application, based on the imposition document and the input data file.

17. The method of claim 1, wherein the plurality of imposition parameters and the identifier assigned to each of the plurality of frames of the template file are stored as part of a document structure associated with the imposition document.

18. The method of claim 1, wherein the plurality of imposition parameters and the identifier assigned to each of the plurality of frames of the template file are stored as part of a separate file associated with the imposition document, where the separate file is stored along with the imposition document.

19. A system to generate a document for printing, the system comprising:
a computing device comprising a processor and a memory, the memory containing instructions that, when executed by the processor, cause the computing device to:
receive, via a user interface, a plurality of imposition parameters for generating a plurality of frames within a template file, wherein the plurality of imposition parameters includes a file path for an input data file, the input data file comprising a plurality of data elements;
generate, based on the plurality of imposition parameters, the plurality of frames within the template file, wherein based on a plurality of data elements present in the input data file, each of the plurality of frames is assigned an identifier to receive a data element from the input data file;
create, based on the template file, an imposition document that includes the plurality of frames, the plurality of imposition parameters, and the identifier assigned to each of the plurality of frames; and
generate an imposed document based on the imposition document and the input data file, wherein generating the document comprises imposing each data element from the input data file into a corresponding frame of the plurality of frames within the imposition document, based on the plurality of imposition parameters and the identifier assigned to each of the plurality of frames.

20. A tangible, non-transitory computer-readable medium for generating a document for printing, having instructions thereon, which, upon being executed by one or more processors, provides for execution of the following steps:
receiving, via a user interface, a plurality of imposition parameters for generating a plurality of frames within a template file, wherein the plurality of imposition parameters includes a file path for an input data file, the input data file comprising a plurality of data elements;
generating, based on the plurality of imposition parameters, the plurality of frames within the template file, wherein based on a plurality of data elements present in the input data file, each of the plurality of frames is assigned an identifier to receive a data element from the input data file;
creating, based on the template file, an imposition document that includes the plurality of frames, the plurality of imposition parameters, and the identifier assigned to each of the plurality of frames; and
generating an imposed document based on the imposition document and the input data file, wherein generating the document comprises imposing each data element from the input data file into a corresponding frame of the plurality of frames within the imposition document, based on the plurality of imposition parameters and the identifier assigned to each of the plurality of frames.
